(19) United States
(12) Patent Application Publication
(10) Pub. No.: US 2026/0089661 A1
(43) Pub. Date: Mar. 26, 2026

(54) VIRTUAL TIME DIVISION DUPLEX PATTERN

(71) Applicant: QUALCOMM Incorporated, San Diego, CA (US)

(72) Inventors: Gideon Shlomo KUTZ, Ramat Hasharon (IL); Lior UZIEL, Hod Hasharon (IL); Yehonatan DALLAL, Kfar Saba (IL); Amit BAR-OR TILLINGER, Tel-Aviv (IL)

(21) Appl. No.: 18/895,163

(22) Filed: Sep. 24, 2024

(51) Int. Cl. H04W 56/00; H04L 5/14

(52) U.S. Cl. CPC H04W 56/0045; H04L 5/14

(57) ABSTRACT

Certain aspects of the present disclosure provide techniques for a virtual time division duplex (TDD) pattern. An example method wireless communications by an apparatus includes obtaining an indication of one or more TDD transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a network entity based at least in part on the time period; and communicating with the network entity based at least in part on the one or more TDD transmission patterns and the duration of the propagation delay.

### FIELD OF THE DISCLOSURE

Aspects of the present disclosure relate to wireless communications, and more particularly, to techniques for time division duplex (TDD) communications.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, or the like. Consequently, there exists a need for further improvements in wireless communications systems to overcome the aforementioned technical challenges and others.

### SUMMARY

One aspect provides a method for wireless communications by an apparatus. The method includes obtaining an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a network entity based at least in part on the time period; and communicating with the network entity based at least in part on the one or more TDD transmission patterns and the duration of the propagation delay.

Another aspect provides a method for wireless communications by an apparatus. The method includes transmitting an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a user equipment based at least in part on the time period; and communicating with the user equipment based at least in part on the one or more TDD transmission patterns and the duration of the propagation delay.

Another aspect provide an apparatus configured for wireless communications. The apparatus includes one or more memories and one or more processors coupled to the one or more memories. The one or more processors are configured to cause the apparatus to obtain an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a network entity based at least in part on the time period; and communicate with the network entity based at least in part on the one or more TDD transmission patterns and the duration of the propagation delay.

Another aspect provide an apparatus configured for wireless communications. The apparatus includes one or more memories and one or more processors coupled to the one or more memories. The one or more processors are configured to cause the apparatus to transmit an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a user equipment based at least in part on the time period; and communicate with the user equipment based at least in part on the one or more TDD transmission patterns and the duration of the propagation delay.

Another aspect provide an apparatus configured for wireless communications. The apparatus includes means for obtaining an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a network entity based at least in part on the time period; and means for communicating with the network entity based at least in part on the one or more TDD transmission patterns and the duration of the propagation delay.

Another aspect provide an apparatus configured for wireless communications. The apparatus includes means for transmitting an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a user equipment based at least in part on the time period; and means for communicating with the user equipment based at least in part on the one or more TDD transmission patterns and the duration of the propagation delay.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment (UE).

FIGS. 4A, 4B, 4C, and 4D depict various example aspects of data structures for a wireless communications network.

FIG. 5 depicts an example non-terrestrial network.

FIG. 6A depicts an example scheme for indicating a timing advance via one or more time division duplex (TDD) transmission patterns.

FIG. 6B depicts an example scheme for indicating a timing advance via multiple TDD patterns.

FIG. 7A depicts another example scheme for indicating a timing advance where a portion of an uplink propagation period is used for downlink communications.

FIG. 7B depicts another example scheme for indicating a timing advance where downlink communications may be extended to overlap with uplink communications.

FIG. 8 depicts a process flow for signaling virtual TDD pattern(s).

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for indicating a timing advance via a “virtual” time division duplex (TDD) transmission pattern. A TDD transmission pattern (hereinafter “TDD pattern”) may define an arrangement of time-domain resources used for downlink and uplink communications, such as the configuration of uplink-downlink slots arranged across a radio frame. In certain cases, a virtual TDD pattern may refer to an uplink-downlink transmission pattern of time-domain resources that is rearranged for actual TDD communications between a user equipment and a network entity as further described herein.

Certain wireless communications systems (e.g., 5G New Radio (NR) systems or any future wireless communications systems) may use a timing advance to control when a user equipment (UE) transmits an uplink transmission to a network entity (e.g., a base station). For example, the UE may transmit the uplink transmission at a time occasion that occurs before the network entity expects to receive the uplink transmission by an amount of time known as the timing advance. In certain cases, the timing advance may have a duration that takes into account the propagation delay between the UE and the network entity as well as certain delay(s) that allow the transceiver of the UE to switch from transmit mode to receive mode or the transceiver of the network entity to switch from receive mode to transmit mode. The timing advance may ensure the uplink transmission from the UE is synchronized with the time at which the network entity expects to receive the uplink transmission. In certain cases, the timing advance may be set to a value that is specific to an individual UE, such that the UE-specific timing advance values ensure the uplink transmissions from the UEs are synchronized with the time at which the network entity expects to receive the uplink transmissions to avoid inter-symbol interference.

Certain wireless communications systems may facilitate communications coverage via a non-terrestrial network (NTN), such as a spaceborne (e.g., satellite) and/or airborne (e.g., airship, balloon, or the like) platform that provides wireless connectivity to UEs. In certain cases, a NTN may communicate with a UE using frequency division duplex (FDD), where uplink and downlink communications may occur at the same time using different carrier frequencies. However, wireless communications at certain high frequencies (such as millimeter wave (mmWave) frequency bands as further described herein) may only use TDD, where uplink and downlink communications may occur at different times using the same carrier. Recently, frequency bands for NTN communications have been expanded to include certain mmWave bands, and thus, in certain cases, NTN communications may also use TDD, for example, for the mmWave bands.

Technical problems for TDD-based NTN communications may include, for example, an effective timing advance for TDD-based NTN communications. Certain wireless communications systems (e.g., 5G NR systems) may specify a maximum allowed value for the timing advance depending on the subcarrier spacing, for example, due to the signaling, which indicates the value of the timing advance, using a non-trivial amount of channel capacity and the field for the timing advance having a fixed payload size. As an example, for a subcarrier spacing of 60 kHz (used for mmWave communications), the timing advance can have a maximum duration of 0.50 ms. Such a maximum duration for the timing advance may also define the maximum supported cell range (e.g., transmission range between the UE and the network entity), for example, due to the propagation delay being proportional to the cell range. In certain cases, for a subcarrier spacing of 60 kHz, the timing advance can support a maximum cell range of 75 kilometers (km). Such a cell range may be less than the altitude of certain low earth orbit (LEO) satellites, for example, having altitudes between 160 kilometers (km) and 1000 km. Expressed another way, the round-trip time for LEO satellites can be about 3.33 ms, which is greater than the maximum allowed duration for a timing advance in mmWave bands (e.g., 0.5 ms). Accordingly, the maximum allowed values for the timing advance in mmWave bands of certain wireless communications systems (e.g., 5G NR systems) may not support the propagation delays and/or cell ranges encountered for certain NTN communications. Note that TDD-based NTN communications at mmWave frequency bands is an example scenario in which the maximum values for the timing advance may be exceeded. Other scenarios (such as terrestrial mm Wave communications) may exceed the maximum values for the timing advance.

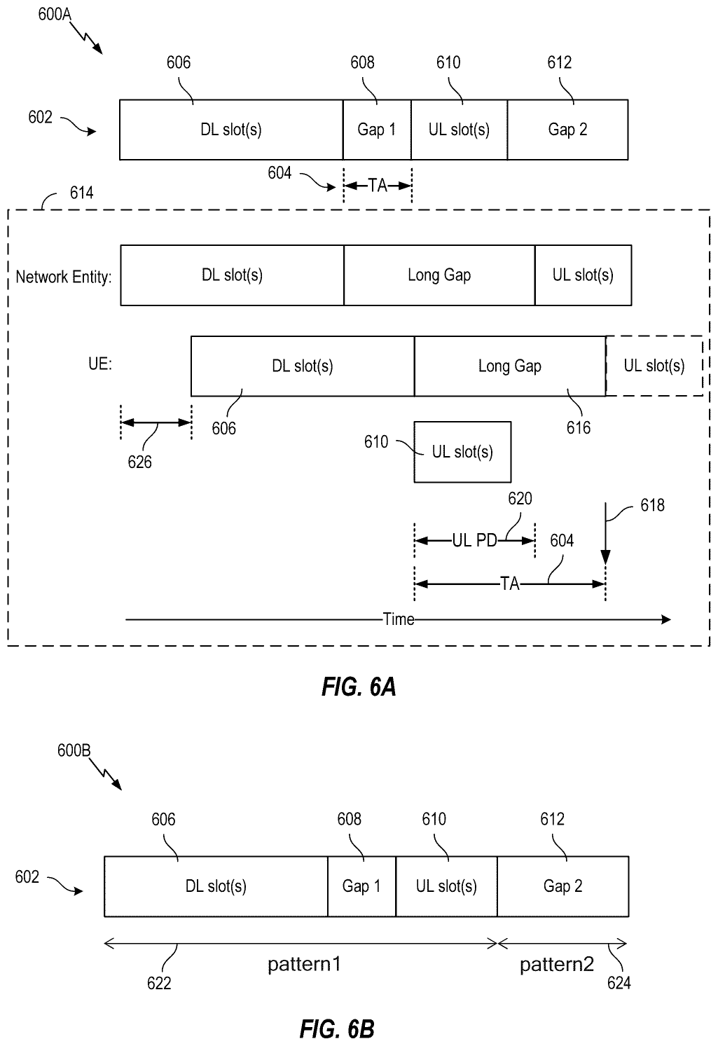

Certain aspects described herein may overcome the aforementioned technical problem(s), for example, by providing one or more virtual TDD patterns that indicate an extended timing advance, for example, that can support certain NTN communications (such as for certain mmWave bands). In certain cases, the virtual TDD pattern(s) may indicate a TDD pattern that is rearranged for communications between a UE and a network entity, where the extended timing advance may be determined based on the rearrangement. In certain aspects, the virtual TDD pattern(s) may indicate a duration for the timing advance to use for uplink transmission(s). As an example, the virtual TDD pattern(s) may extend a previous duration of the timing advance, such as the maximum duration discussed herein. In certain cases, the virtual TDD pattern(s) may indicate that one or more time gaps are arranged among the uplink-downlink slots of a TDD pattern, and the duration of the time gap(s) may be used to determine the extended timing advance. As an example, a first TDD pattern may indicate a first time gap, and a second TDD pattern may indicate a second time gap, where the duration of the timing advance may be based at least in part on the first time gap and the second time gap, for example, as further described herein with respect to FIG. 6A.

Certain techniques for indicating an extended timing advance via virtual TDD pattern(s) described herein may provide various beneficial technical effects and/or advantages. The techniques for indicating an extended timing advance may enable improved wireless communications performance, such as increased cell ranges, reduced latencies, and/or increased throughputs. The increased cell ranges may enable larger coverage areas (e.g., NTN communications) for certain frequency bands, such as mmWave frequecy bands. The reduced latencies and/or increased throughput may be attributable to NTN communication via mmWave frequency bands, which may be enabled through the extended timing advance.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

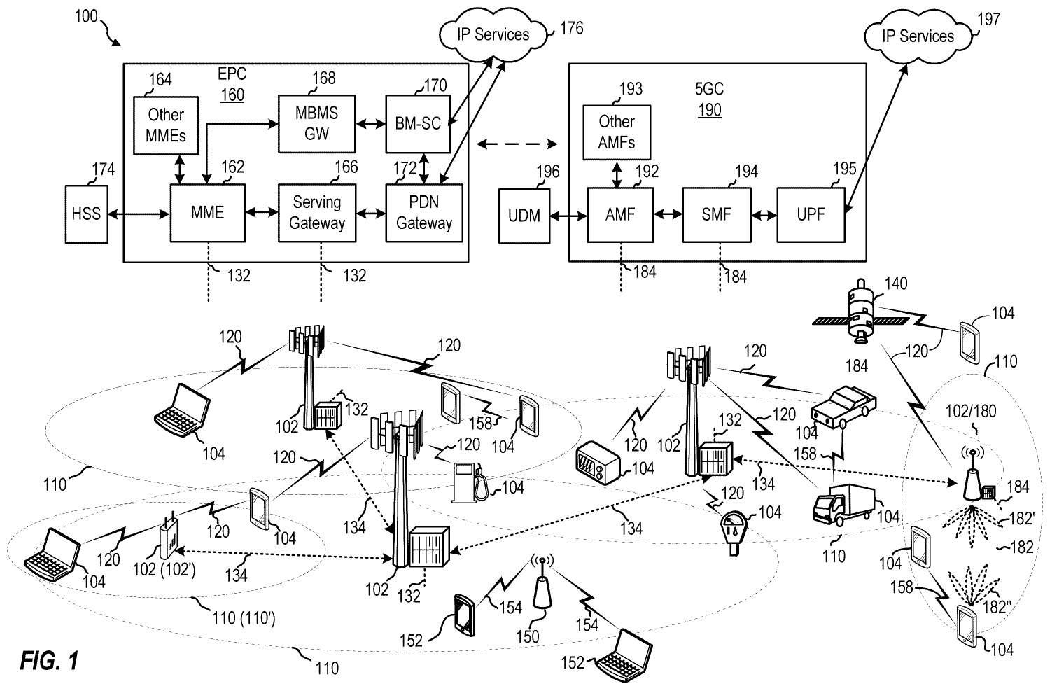

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 includes terrestrial aspects, such as ground-based network entities (e.g., BSs 102), and non-terrestrial aspects (also referred to herein as non-terrestrial network entities), such as satellite 140 and/or aerial or spaceborne platform(s), which may include network entities on-board (e.g., one or more BSs) capable of communicating with other network elements (e.g., terrestrial BSs) and UEs.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, data centers, or other similar devices. UEs 104 may also be referred to more generally as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

Generally, a cell may refer to a portion, partition, or segment of wireless communication coverage served by a network entity within a wireless communication network. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

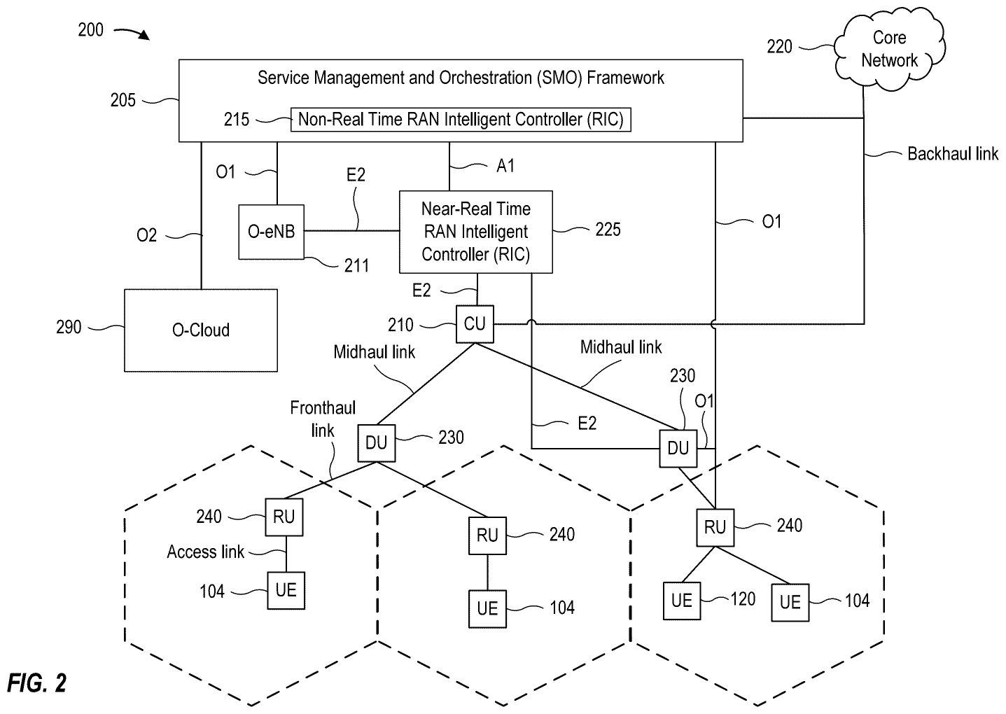

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via 01) or via creation of RAN management policies (such as A1 policies).

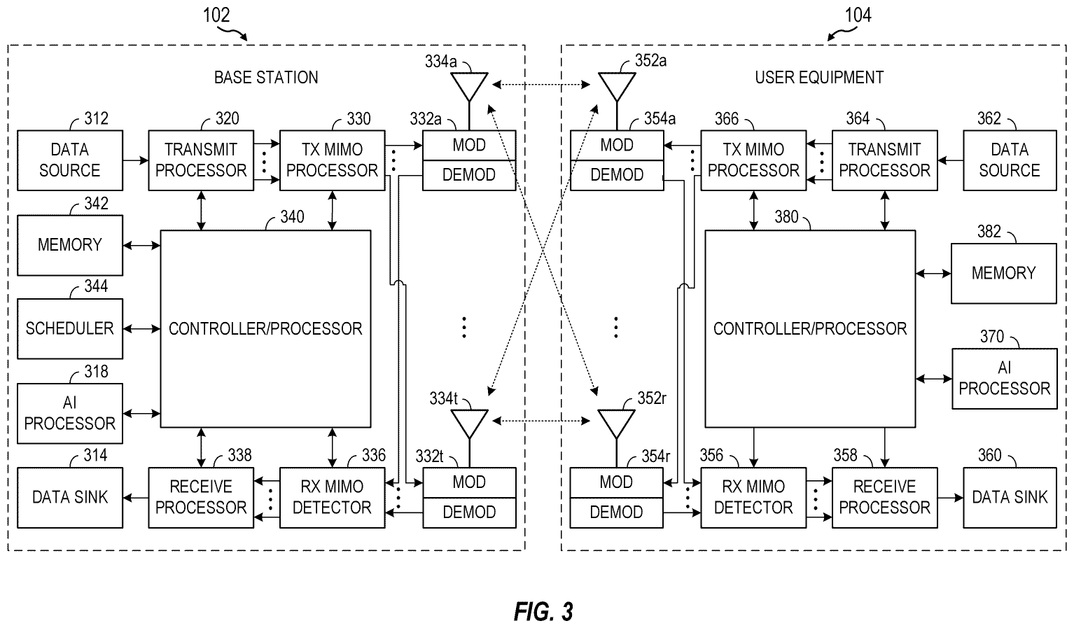

FIG. 3 depicts aspects of an example BS 102 and a UE 104.

Generally, BS 102 includes various processors (e.g., 318, 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 314). For example, BS 102 may transmit and receive data between BS 102 and UE 104. BS 102 includes controller/processor 340, which may be configured to implement various functions described herein related to wireless communications. Note that the BS 102 may have a disaggregated architecture as described herein with respect to FIG. 2.

Generally, UE 104 includes various processors (e.g., 358, 364, 366, 370, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

RX MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a RX MIMO detector 336 if applicable, and further processed by a receive processor 338 to obtain decoded data and control information sent by UE 104. Receive processor 338 may provide the decoded data to a data sink 314 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

In various aspects, artificial intelligence (AI) processors 318 and 370 may perform AI processing for BS 102 and/or UE 104, respectively. The AI processor 318 may include AI accelerator hardware or circuitry such as one or more neural processing units (NPUs), one or more neural network processors, one or more tensor processors, one or more deep learning processors, etc. The AI processor 370 may likewise include AI accelerator hardware or circuitry. As an example, the AI processor 370 may perform AI-based beam management, AI-based channel state feedback (CSF), AI-based antenna tuning, and/or AI-based positioning (e.g., non-line of sight positioning prediction). In some cases, the AI processor 318 may process feedback from the UE 104 (e.g., CSF) using hardware accelerated AI inferences and/or AI training. The AI processor 318 may decode compressed CSF from the UE 104, for example, using a hardware accelerated AI inference associated with the CSF. In certain cases, the AI processor 318 may perform certain RAN-based functions including, for example, network planning, network performance management, energy-efficient network operations, etc.

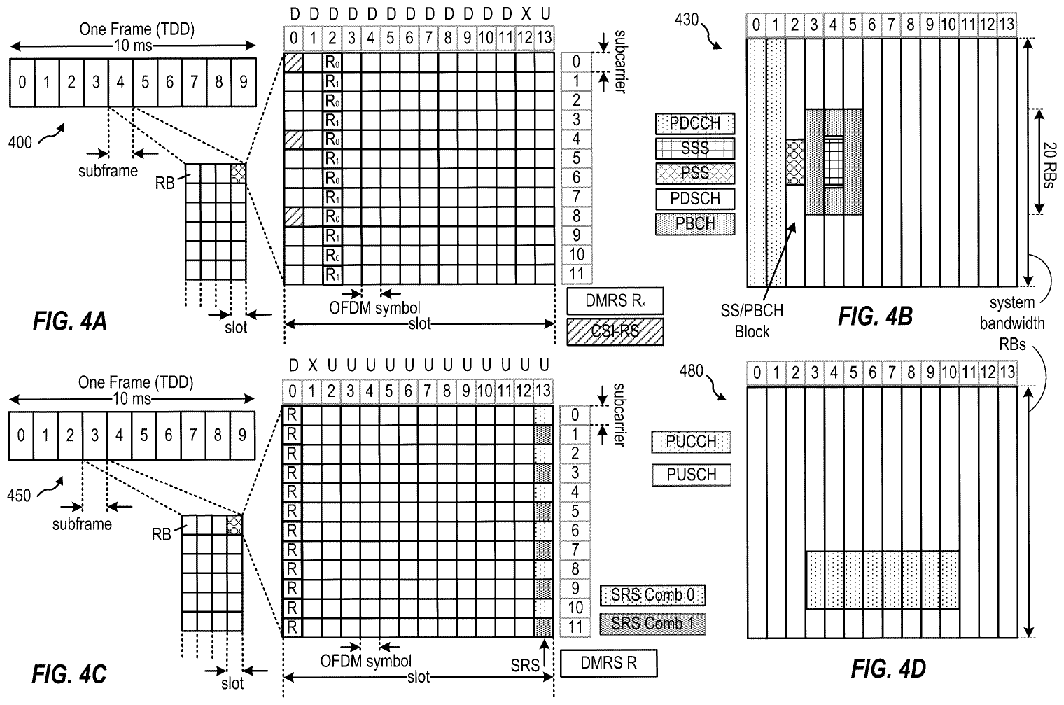

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for both DL and UL. Wireless communications frame structures may also be time division duplex (TDD), in which, for a particular set of subcarriers, subframes within the set of subcarriers are dedicated for either DL or UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology, which may define a frequency domain subcarrier spacing and symbol duration as further described herein. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, the extended CP (e.g., 12 symbols per slot) may be used with a specific numerology, e.g., numerology 2 allowing for 4 slots per subframe. The subcarrier spacing and symbol length/duration are a function of the numerology. The subcarrier spacing may be equal to 2^{μ}×15 kHz, where u is the numerology 0 to 6. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Non-Terrestrial Network Communications

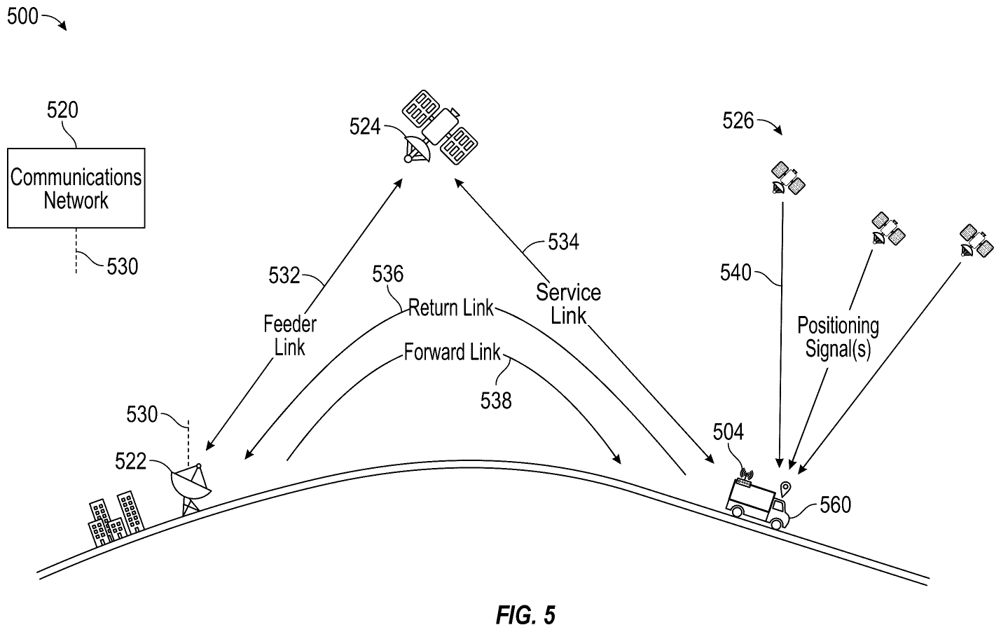

FIG. 5 depicts an example non-terrestrial network (NTN) 500. In this example, the NTN 500 includes a communications network 520 (e.g., the EPC 160 and/or the 5GC network 190 of FIG. 1), an NTN gateway 522, and an NTN payload 524. The NTN 500 may facilitate wireless communications with one or more UEs 504 (e.g., the UE 104 of FIG. 1). As an example, and shown in FIG. 5, the UE 504 may include an IoT sensor and/or identification tag affixed to a vehicle 560. The NTN 500 may allow the UE 504 to be in a coverage area for wireless communications even where the vehicle 560 travels great distances, for example, across one or more countries, or is stationed in certain locations lacking a terrestrial communications network. Note that an IoT device is an example of a UE, and other UEs may be capable of NTN communications.

The NTN gateway 522 may communicate with the communications network 520 via one or more interfaces 530, such as backhaul links including NG interface(s) and/or S1 interface(s) between a RAN and a core network. The interface(s) 530 may include wired and/or wireless connections. The NTN gateway 522 may serve one or more NTN payloads 524.

The NTN payload 524 may be or include one or more airborne platforms (e.g., a drone or balloon) and/or one or more spaceborne platforms (e.g., the satellite 140 as depicted in FIG. 1). The NTN payload 524 may be served by one or more NTN gateways 522. In certain aspects, the NTN payload 524 may include any of various non-terrestrial network entities and/or platforms that provide radio access through Geosynchronous orbits (GSO), Non-Geosynchronous Orbit (NGSO), which includes Low-Earth Orbit (LEO) and Medium Earth Orbit (MEO), or High Altitude Platform Systems (HAPS).

The NTN payload 524 may transparently forward communications (e.g., the radio protocol) received from the UE 504 (via a service link 534) to the NTN gateway 522 (via a feeder link 532), and/or vice-versa. The NTN gateway 522 and the NTN payload 524 may communicate via a wireless communication link referred to as the feeder link 532, and the NTN payload 524 may communicate with the UE 504 via a wireless communication link referred to as the service link 534. In some cases, the transparent links between the NTN gateway 522 and the UE 504 may be referred to as a return link 536 for communications from the UE 504 to the NTN gateway 522 and as a forward link 538 for communications from the NTN gateway 522 to the UE 504. In certain aspects, for communications from the NTN gateway 522, the NTN payload 524 may change the carrier frequency used on the feeder link 532, before re-transmitting the communications on the service link 534, and/or vice versa (respectively on the feeder link).

The service link 534 may include an Earth-fixed service link, a quasi-Earth-fixed service link, and/or an Earth-moving service link. An Earth-fixed service link may be implemented by beam(s) continuously covering the same geographical area(s) all the time (e.g., the case of GSO satellites). A quasi-Earth-fixed service link may be provisioned by beam(s) covering one geographic area for a limited period and a different geographic area during another period (e.g., the case of NGSO satellites generating steerable beams). An Earth-moving service link may be provisioned by beam(s) with a coverage area that slides over the Earth surface (e.g., the case of NGSO satellites generating fixed or non-steerable beams).

In certain aspects, the UE 504 may be in communication with a global navigation satellite system (GNSS) 526. For example, the UE 504 may receive positioning signal(s) 540 from the GNSS 526, and the positioning signal(s) 540 may provide certain information for synchronizing (e.g., time and/or frequency synchronization) the service link 534. The UE 504 may obtain an indication of the location of the NTN payload 524 via system information from the NTN payload 524. In certain cases, the UE 504 may estimate a timing delay and/or Doppler effects associated with the service link 534 using the positioning signal(s) 540 and the location of the NTN payload 524.

In certain aspects, the timing advance (TTA) may be determined according to the following expression:

$${T}_{TA} = ( {N}_{TA , offset} + {N}_{TA} ) \times {T}_{c}$$

where N_{TA}×T_{c} corresponds to the round trip propagation delay between a UE and a network entity, and N_{TA,offset}×T_{c} corresponds to the transceiver switching time allowed for the network entity to switch from receive mode to transmit mode. The round trip propagation delay may be equal to or based on the sum of the downlink propagation delay and the uplink propagation delay. Accordingly, the timing advance may be a function of the propagation delay between the UE and the network entity, for example, associated with the service link 534 of FIG. 5.

### Aspects Related to Virtual Time Division Duplex Pattern

Aspects of the present disclosure provide techniques for indicating an extended timing advance via one or more virtual TDD patterns. Such an extended timing advance may support extended cell ranges, for example, for certain NTN communications in mmWave frequency bands. The techniques for indicating an extended timing advance may enable increased cell ranges, reduced latencies, and/or increased throughput.

FIG. 6A depicts an example scheme 600A for indicating a timing advance via one or more TDD transmission patterns (hereinafter “the TDD pattern 602”). In this example, a UE may obtain an indication of a first duration of a timing advance, for example, via a pre-configuration and/or signaling, such as system information, radio resource control (RRC) signaling, medium access control (MAC) signaling, downlink control information (DCI), and/or the like. The first duration may have a duration that satisfies the maximum allowed duration of the timing advance as described herein.

The UE may obtain an indication of the TDD pattern 602, for example, via signaling, such as system information, RRC signaling, MAC signaling, DCI, and/or the like. The TDD pattern 602 may indicate a duration of a propagation delay for communications with a network entity, such as an uplink propagation delay 620, as further described herein. In certain aspects, a second duration of the timing advance 604 may be based on the propagation delay, and the second duration of the timing advance 604 may provide an extended duration of the timing advance 604 relative to the first duration. In certain cases, the UE may be configured to use certain aspects of the TDD pattern 602 to communicate uplink signaling in timing synchronization with the network entity without the UE being aware of the second duration of the timing advance 604, as further described herein. For example, the TDD pattern 602 may allow the UE to communicate uplink signaling using the first duration of the timing advance 604. In certain cases, the UE may be configured to use certain aspects of the TDD pattern 602 to determine the second duration of the timing advance 604 for uplink communications as further described herein. The second duration may be greater than the maximum allowed duration of the timing advance. Accordingly, the TDD pattern 602 may enable communications for extended cell ranges, such as the cell ranges used for NTN communications in mmWave frequency band(s).

The TDD pattern 602 may include one or more downlink slots 606, a first time gap 608, one or more uplink slots 610, and a second time gap 612. The TDD pattern 602 may indicate the total number of slots for the one or more downlink slots 606 (e.g., the duration associated with the one or more downlink slots 606) and the total number of slots for the one or more uplink slots 610. The TDD pattern 602 may further indicate the duration of the first time gap 608 and the duration of the second time gap 612. The TDD pattern 602 may indicate that the one or more downlink slots 606 are followed in time by the first time gap 608, then by the one or more uplink slots 610, and then by the second time gap 612. For example, the TDD pattern 602 may indicate that the one or more downlink slots 606, the first time gap 608, the one or more uplink slots 610, and the second time gap 612 are arranged in the respective order of a sequence. In certain aspects, the TDD pattern 602 may indicate any number of downlink slots and/or uplink slots that occur in time before or after the one or more downlink slots 606 and/or the second time gap 612.

The TDD pattern 602 may indicate an actual frame timing 614 applied at a network entity and the UE, respectively. For example, the TDD pattern 602 may be a virtual TDD pattern that is effectively rearranged for communications between the network entity and the UE. The durations of the first time gap 608 and the second time gap 612 may be determined to allow the UE to apply the first duration of the timing advance 604 without being aware of the second duration of the timing advance 604. The duration of the first time gap 608 may correspond to or be based on the first duration of the timing advance 604. The UE may interpret the first time gap 608 as indicating the time occasion of when to transmit uplink signaling for communications in the one or more uplink slots 610. The UE may determine the time occasion to transmit uplink signaling based on the first duration of the timing advance 604 with respect to the time occasion of when downlink signaling associated with the one or more downlink slots 606 is expected to be received at the UE (such as the last symbol of the downlink signaling). Accordingly, the first time gap 608 may indicate a virtual delay between the one or more downlink slots 606 and the one or more uplink slots 610 that allows the UE to communicate uplink signaling in timing synchronization with the network entity based on the first duration of the timing advance 604.

With respect to the frame timing applied or encountered at the UE, the TDD pattern 602 may indicate that the one or more downlink slots 606 are followed in time by a third time gap 616 (depicted as “Long gap”), which may include the first time gap 608 and/or the second time gap 612. In certain cases, the UE may be configured to effectively convert the first time gap 608 and the second time gap 612 into the third time gap 616 and arrange the third time gap 616 after the one or more downlink slot(s) 606. During the third time gap 616, the UE may transmit signaling in the one or more uplink slots 610 beginning at a time occasion determined based on the timing advance 604 according to the second duration. As an example, the beginning of the one or more uplink slots 610 as applied at the UE may be shifted in time by the timing advance 604 relative to a timing reference 618 (e.g., downlink timing reference associated with a downlink frame, which may be determined according to synchronization signaling) obtained at the UE. Note that the frame timing 614 applied at the network entity is offset 626 in time from the frame timing applied at the UE, for example, due in part to the propagation delay for communications between the UE and the network entity.

In certain cases, the UE may be configured to effectively rearrange the TDD pattern 602 into the actual frame timing 614 and determine a time occasion of when to transmit signaling for uplink communications in the one or more uplink slots 610, for example, based on the second duration of the timing advance 604. The UE may determine the second duration of the timing advance 604 based at least in part on the first time gap 608 and/or the second time gap 612 of the TDD pattern 602. As an example, the first time gap 608 may be or indicate a UE-specific portion of the round trip propagation delay for communications between the UE and the network entity. The round trip propagation delay may include an uplink propagation delay 620 (or propagation time period) and a corresponding propagation delay for downlink communications. The first time gap 608 may be or indicate a UE-specific delay among relative delays throughout the coverage area of a cell. The second time gap 612 may be or indicate any remaining time for the round trip propagation delay, such as a base duration, minimum duration (e.g., corresponding to a minimum cell range), or maximum duration (e.g., corresponding to a maximum cell range) for the round trip propagation delay. For example, the first time gap 608 may be used to provide an optional UE-specific time period that adjusts (increases or decreases) the base duration corresponding to the second time gap 612. In certain cases, the first time gap 608 may have a value of zero, for example, corresponding to the maximum cell range of the network entity. In certain aspects, the first time gap 608 and/or the second time gap 612 may further indicate a guard period that ensures enough time for the UE to switch from a receive mode to a transmit mode.

In certain aspects, the second duration of the timing advance 604 may be based at least in part on a sum of the first time gap 608 and the second time gap 612. In certain cases, the sum of the first time gap 608 and the second time gap 612 may be equal to at least a portion of the second duration of the timing advance 604. For example, the sum of the first time gap 608 and the second time gap 612 may indicate the round trip propagation delay (e.g., N_{TA}×T_{c}) or a portion thereof, such as the uplink propagation delay 620 and/or the downlink propagation delay. To determine the second duration, the UE may use the value of N_{TA,offset}×T_{c} obtained with respect to the first duration of the timing advance along with the propagation delay indicated based on the first time gap 608 and/or the second time gap 612. In certain cases, the first time gap 608 and the second time gap 612 may indicate the entire duration of the timing advance 604.

Accordingly, the indication of the second duration of the timing advance via the TDD pattern 602 may enable increased cell ranges, reduced latencies, and/or increased throughput, for example, through NTN communications via mm Wave frequency bands.

FIG. 6B depicts an example scheme 600B for indicating the timing advance 604 of FIG. 6A via multiple TDD patterns. In this example, the TDD pattern 602 may include a first TDD pattern 622 (depicted as “pattern1”) and a second TDD pattern 624 (depicted as “pattern2”). In certain aspects, the first TDD pattern 622 and the second TDD pattern 624 may be indicated via or included in a TDD configuration. The TDD configuration may be communicated via system information, RRC signaling, MAC signaling, DCI, and/or the like. When the TDD configuration includes the first TDD pattern 622 and the second TDD pattern 624, the second TDD pattern 624 may follow the first TDD pattern 622 in time, and the combination of TDD patterns 622, 624 may repeat with the combined periodicity of the first TDD pattern 622 and the second TDD pattern 624.

The first TDD pattern 624 may indicate or include the one or more downlink slot(s) 606, the first time gap 608, and the one or more uplink slots 610, for example, arranged as described herein with respect to FIG. 6A. The second TDD pattern 624 may indicate or include the second time gap 612. In certain aspects, the second time gap 612 may be indicated based on a duration of a periodicity for the second TDD pattern 624. For example, the second TDD pattern 624 may be defined as having a periodicity without any uplink slots and/or any downlink slots, and the duration of the periodicity for the second TDD pattern 624 may be or indicate the duration of the second time gap 612.

Note that the arrangement of the first TDD pattern 622 and the second TDD pattern 624 is an example of the TDD pattern 602 being defined in terms of multiple sub-TDD patterns. Aspects of the present disclosure may be applied to any suitable arrangement or segmentation for a TDD pattern (e.g., the TDD pattern 602 of FIG. 6A) among multiple sub-TDD patterns may be applied.

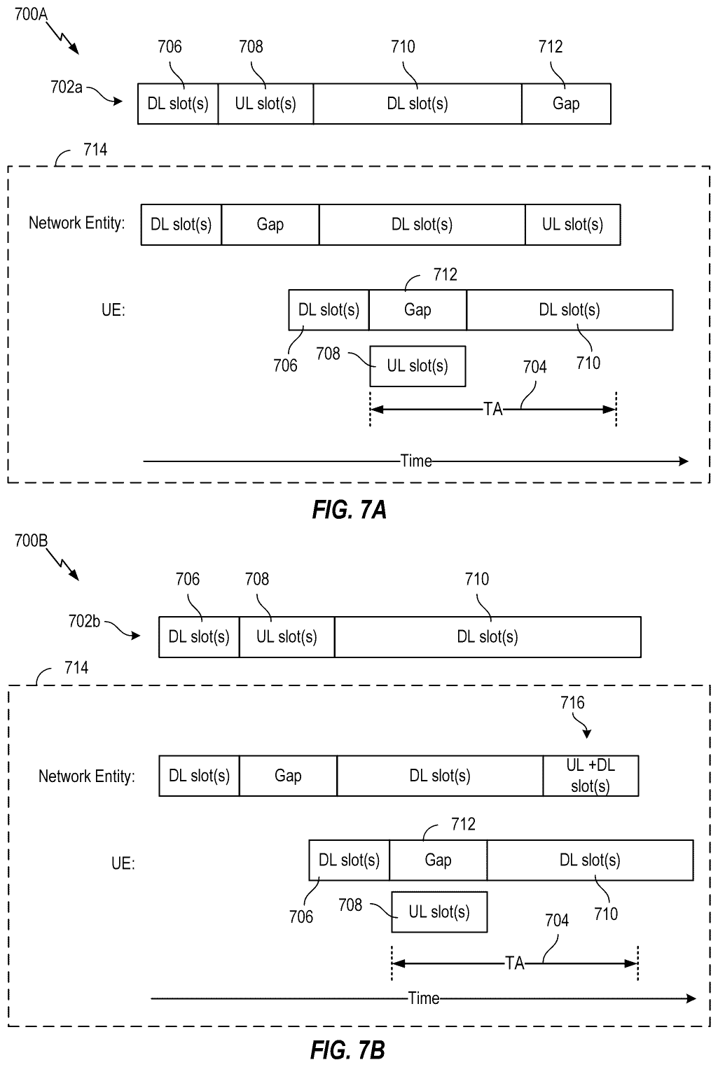

FIG. 7A depicts another example scheme 700A for indicating a timing advance where a portion of propagation period is used for downlink communications. In this example, a TDD pattern 702a may indicate or include one or more first downlink slots 706, one or more uplink slots 708, one or more second downlink slots 710, and a time gap 712, for example, arranged in the order as depicted. The TDD pattern 702a may also indicate the total number of slots for the one or more first downlink slots 706, the one or more uplink slots 708, and the one or more second downlink slots 710, respectively. The TDD pattern 702a may indicate the duration of the time gap 712. In certain cases, the TDD pattern 702a may include another time gap (not shown) arranged between the one or more first downlink slots 706 and the one or more uplink slots 708, for example, as described herein with respect to FIG. 6A. The other optional time gap may correspond to the first time gap of FIG. 6A, for example, to indicate a UE-specific portion of a round trip propagation delay. The duration of the one or more second downlink slots 710 and the time gap 712 may be or indicate any remaining duration of the round trip propagation delay or a portion thereof, for example, as described herein with respect to the second time gap 612 of FIG. 6A. The TDD pattern 702a may indicate the second duration of the timing advance 704, for example, based at least in part on the one or more second downlink slots 710 and the time gap 712 (and in certain cases, the other optional time gap). For example, the duration of the round trip propagation delay (or a portion thereof) may be based on the sum of the one or more second downlink slots 710 and the time gap 712 (and in certain cases, the other time gap).

The TDD pattern 702a may indicate an actual frame timing 714 applied at the network entity and the UE, respectively. For example, the UE may be configured to rearrange the TDD pattern 702a into the actual frame timing 714 and determine the second duration of the timing advance 704 for the one or more uplink slots 708. With respect to the frame timing applied or encountered at the UE, the TDD pattern 702a may indicate that the one or more first downlink slots 706 are followed in time by the time gap 712 and then by the one or more second downlink slots 710. The UE may be configured to arrange the time gap 712 between the one or more first downlink slot(s) 706 and the one or more second downlink slots 710. During the time gap 712, the UE may transmit first signaling in the one or more uplink slots 708 beginning at a time occasion determined based on the timing advance 704, for example, as described herein with respect to FIG. 6A. The UE may obtain second signaling in the one or more second downlink slots 710 or a portion thereof during at least a portion of the propagation period of the one or more uplink slots 708. For example, after transmitting the first signaling in the one or more uplink slots 708, the UE may obtain signaling in the one or more second downlink slots 710. Accordingly, communicating via the one or more second downlink slots 710 during the propagation period of the first signaling may enable reduced latencies, increased throughput, and/or improved channel usage for downlink communications.

In certain aspects, an arrangement of sub-TDD patterns as described herein with respect to FIG. 6A may indicate the TDD pattern 702a. For example, a first TDD pattern may indicate or include the one or more first downlink slots 706, the other optional time gap, and the one or more uplink slots 708; and a second TDD pattern may indicate or include the one or more second downlink slots 710 and the time gap 712.

FIG. 7B depicts another example scheme 700B for indicating a timing advance where the downlink communications of FIG. 7A may be extended to overlap with the uplink communications associated with the one or more uplink slots 708. In this example, the TDD pattern 702b may indicate or include the one or more first downlink slots 706, the one or more uplink slots 708, and the one or more second downlink slots 710, for example, arranged in the order as depicted. The TDD pattern 702b may also indicate the total number of slots for the one or more first downlink slots 706, the one or more uplink slots 708, and the one or more second downlink slots 710, respectively. In certain cases, the TDD pattern 702b may include the optional time gap (not shown) arranged between the one or more first downlink slots 706 and the one or more uplink slots 708, for example, as described herein with respect to FIGS. 6A and 7A. The duration of the one or more second downlink slots 710 may indicate any remaining duration of the round trip propagation delay, for example, as described herein with respect to the second time gap 612 of FIG. 6A. The TDD pattern 702b may indicate the second duration of the timing advance 704, for example, based at least in part on the one or more second downlink slots 710 (and in certain cases, the other optional time gap). In certain aspects, the UE may obtain an indication that a portion of the one or more second downlink slots 710 are expected to overlap in time with the one or more uplink slots 708 at the network entity. The non-overlapping portion of the one or more second downlink slots 710 may be used to indicate the second duration of the timing advance 704.

The TDD pattern 702b may indicate the actual frame timing 714 applied at the network entity and the UE, respectively. With respect to the frame timing applied or encountered at the UE, the TDD pattern 702b may indicate that the one or more first downlink slots are followed in time by the time gap 712 and then by the one or more second downlink slots 710. The UE may be configured to arrange the time gap 712 between the one or more first downlink slot(s) 706 and the one or more second downlink slots 710. During the time gap 712, the UE may transmit first signaling in the one or more uplink slots 708 beginning at a time occasion determined based on the timing advance 704, for example, as described herein with respect to FIG. 6A. The UE may obtain second signaling in the one or more second downlink slots 710 or a portion thereof during at least a portion of the propagation period of the one or more uplink slots 708. A portion of the one or more second downlink slots 710 (e.g., at least one downlink slot) may overlap in time with the one or more uplink slots 708 for FDD communications 716 at the network entity. Accordingly, the FDD communications at the network entity may enable reduced latencies, increased throughput, and/or improved channel usage.

In certain aspects, an arrangement of sub-TDD patterns as described herein with respect to FIG. 6A may indicate the TDD pattern 702b. For example, a first TDD pattern (e.g., the first TDD pattern 622) may indicate or include the one or more first downlink slots 706, the other optional time gap, and the one or more uplink slots 708; and a second TDD pattern (e.g., the second TDD pattern 624) may indicate or include the one or more second downlink slots 710.

Note that the examples of FIGS. 6A-7B use a granularity of the TDD pattern(s) in terms of slots to facilitate an understanding of TDD pattern(s) used to indicate a duration of a timing advance. Aspects of the present disclosure may apply to a TDD pattern that uses any suitable transmission time interval or unit of a time-domain resource.

### Example Signaling Related to Virtual Time Division Duplex Pattern

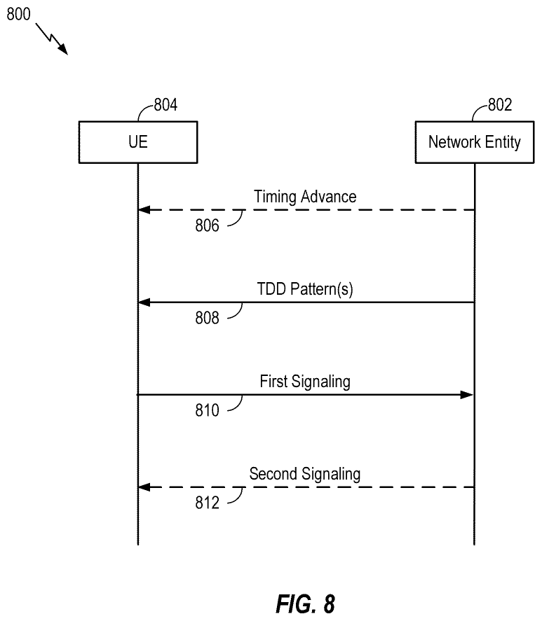

FIG. 8 depicts a process flow 800 for signaling virtual TDD pattern(s) in a network between a network entity 802 and a user equipment (UE) 804. In some aspects, the network entity 802 may be an example of the BS 102 depicted and described with respect to FIGS. 1 and 3 or a disaggregated base station depicted and described with respect to FIG. 2. In certain aspects, the network entity 802 may be an example of an NTN payload and/or an NTN gateway as described herein with respect to FIG. 5. Similarly, the UE 804 may be an example of UE 104 depicted and described with respect to FIGS. 1 and 3. However, in other aspects, UE 804 may be another type of wireless communications device and network entity 802 may be another type of network entity or network node, such as those described herein. Note that any operations or signaling illustrated with dashed lines may indicate that that operation or signaling is an optional or alternative example.

At 806, the UE 804 optionally obtains, from the network entity 802, an indication of a first duration of the timing advance. In certain aspects, the first duration of the timing advance may include a component of the timing advance, such as N_{TA,offset}×T_{c}. The UE 804 may use the value of N_{TA,offset}×T_{c} to determine a second duration of the timing advance as discussed herein. The indication of the first duration of the timing advance may be communicated via system information, RRC signaling, MAC signaling, DCI, and/or the like. As an example, the first duration of the timing advance may be communicated via MAC signaling, for example, during a random access procedure.

At 808, the UE 804 obtains, from the network entity 802, an indication of one or more TDD patterns that indicate a second duration of the timing advance, for example, as described herein with respect to FIGS. 6A-7B. As an example, the TDD pattern(s) may be or include the TDD pattern 602 of FIG. 6A. The indication of the TDD pattern(s) may be communicated via system information, RRC signaling, MAC signaling, DCI, and/or the like. The indication of the second duration may enable increased cell ranges, reduced latencies, and/or increased throughput. For example, the indication of the second duration may enable TDD communications for mmWave frequency band(s) via an extended cell range, such as the cell range of NTN communications.

At 810, the UE 804 transmits, to the network entity 802, first signaling in one or more uplink slots of the TDD pattern(s) in accordance with the second duration of the timing advance. As an example, the UE 804 may transmit the first signaling in the one or more uplink slots beginning at a time occasion relative to the timing advance, as described herein with respect to FIG. 6A.

At 812, the UE 804 optionally obtains, from the network entity 802, second signaling in one or more downlink slots, for example, as described herein with respect to FIGS. 7A and 7B. In certain cases, the one or downlink slots may be communicated during the propagation period of the one or more uplink slots, for example, as described herein with respect to FIG. 7A. In certain cases, a portion of the one or more downlink slots may overlap in time with the one or more uplink slots at the network entity 802 for FDD communications.

Note that the process flow illustrated in FIG. 8 is described herein to facilitate an understanding of virtual TDD pattern(s) that indicate a timing advance, and aspects of the present disclosure may be performed in various manners via alternative or additional signaling and/or operations. In certain aspects, the operations and/or signaling of FIG. 8 may occur in an order different from that described or depicted, and various actions, operations, and/or signaling may be added, omitted, or combined.

### Example Operations Related to Virtual Time Division Duplex Pattern

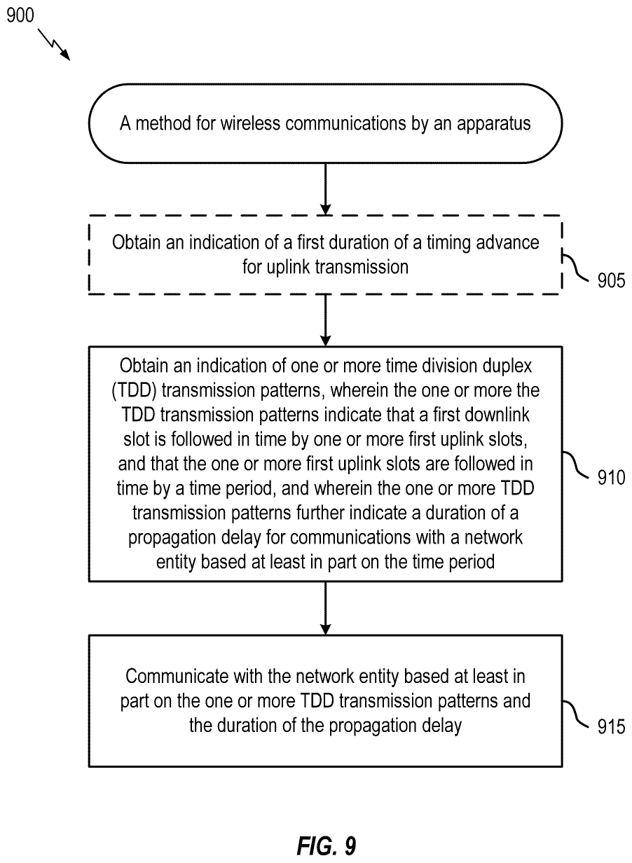

FIG. 9 shows a method 900 for wireless communications by an apparatus, such as UE 104 of FIGS. 1 and 3.

Method 900 optionally begins at block 905 with obtaining an indication of a first duration of a timing advance for uplink transmission, for example, as described herein with respect to FIG. 8.

Method 900 then proceeds to block 910 with obtaining an indication of one or more TDD transmission patterns, wherein the one or more TDD transmission patterns indicate that a first downlink slot is followed in time by one or more first uplink slots, and that the one or more first uplink slots are followed in time by a time period (such as the second time gap 612 or a portion of the one or more second downlink slots 710), wherein the one or more TDD transmission patterns further indicates a propagation delay for communications with a network entity based at least in part on the time period, for example, as described herein with respect to FIGS. 6A-8.

Method 900 then proceeds to block 915 with communicating with the network entity based at least in part on the one or more TDD transmission patterns and the duration of the propagation delay. In certain aspects, the one or more TDD transmission patterns further indicates a second duration of the timing advance based at least in part on the duration of the propagation delay. In certain aspects, block 915 includes transmitting signaling, scheduled in the one or more first uplink slots, beginning at a time occasion based at least in part on a second duration of the timing advance, for example, as described herein with respect to FIG. 6A. In certain aspects, the second duration of the timing advance is greater than the first duration of the timing advance.

In certain aspects, the one or more TDD transmission patterns indicate that a first time gap is arranged in time between the first downlink slot and the one or more first uplink slots, the one or more TDD transmission patterns indicate that the one or more first uplink slots are followed in time by a second time gap. In certain aspects, the duration of the propagation delay is based at least in part on the first time gap and the second time gap, and the time period includes the second time gap. In certain aspects, the second duration of the timing advance is based at least in part on the first time gap and the second time gap.

In certain aspects, the duration of the propagation delay is based at least in part on a sum of the first time gap and the second time gap. In certain aspects, the second duration of the timing advance is based at least in part on a sum of the first time gap and the second time gap.

In certain aspects, the one or more TDD transmission patterns include a first TDD transmission pattern and a second TDD transmission pattern, the first TDD transmission pattern indicates that the first time gap is arranged in time between the first downlink slot and the one or more first uplink slots, and the second TDD transmission pattern indicates a duration of the second time gap.

In certain aspects, the one or more TDD transmission patterns further indicate that the one or more first uplink slots are followed in time by one or more second downlink slots, and that the one or more second downlink slots are allocated during a propagation time period associated with the one or more first uplink slots, wherein the duration of the propagation delay includes the propagation time period. In certain aspects, the second duration of the timing advance includes the propagation time period.

In certain aspects, the one or more TDD transmission patterns include a first TDD transmission pattern and a second TDD transmission pattern, the first TDD transmission pattern indicates that the first downlink slot is followed in time by the one or more first uplink slots, and the second TDD transmission pattern indicates that the one or more first uplink slots are followed in time by the one or more second downlink slots. In certain aspects, the time period includes at least a portion of the one or more second downlink slots.

In certain aspects, the one or more TDD transmission patterns further indicate that the one or more second downlink slots include at least one downlink slot that overlaps in time with at least one uplink slot of the one or more first uplink slots for frequency division duplex communications at the network entity.

In certain aspects, block 915 includes transmitting signaling to the network entity via an NTN communications link, such as the service link 534 of FIG. 5.

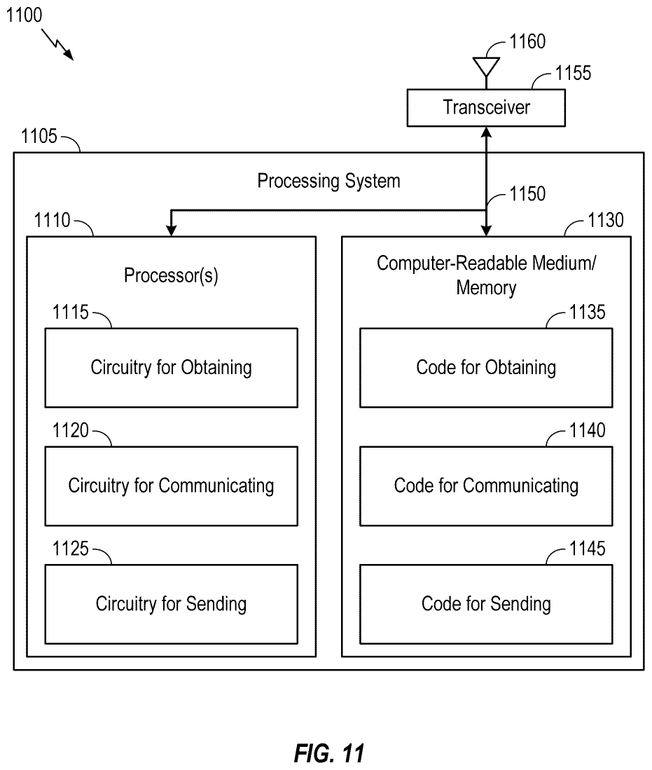

In certain aspects, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

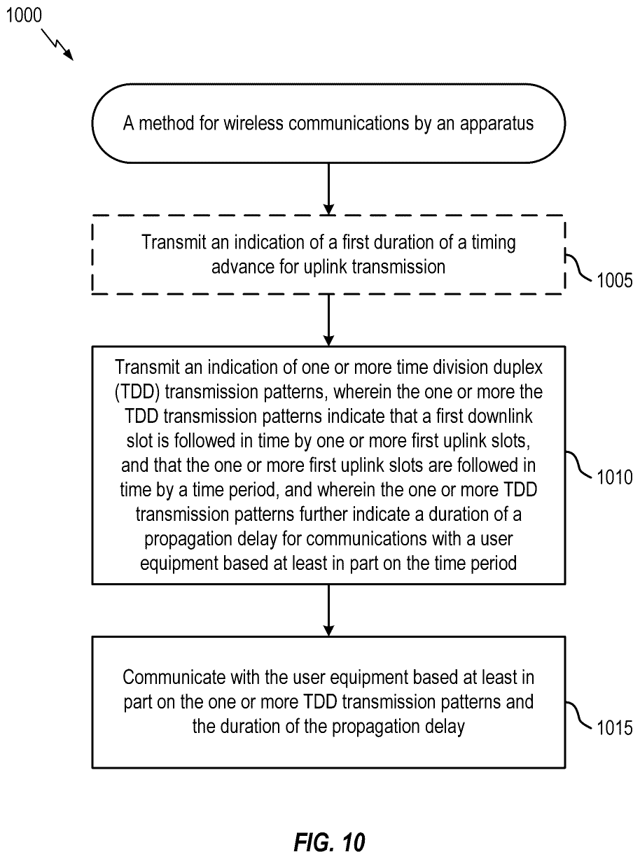

FIG. 10 shows a method 1000 for wireless communications by an apparatus, such as BS 102 of FIGS. 1 and 3, or a disaggregated base station as discussed with respect to FIG. 2. In certain aspects, the apparatus may be or include an NTN payload as described herein with respect to FIG. 5.

Method 1000 optionally begins at block 1005 with transmitting an indication of a first duration of a timing advance for uplink transmission for example, as described herein with respect to FIG. 8.

Method 1000 then proceeds to block 1010 with transmitting an indication of one or more TDD transmission patterns, wherein the one or more TDD transmission patterns indicate that a first downlink slot is followed in time by one or more first uplink slots, and that the one or more first uplink slots are followed in time by a time period (such as the second time gap 612 or a portion of the one or more second downlink slots 710), and wherein the one or more TDD transmission patterns further indicates a duration of a propagation delay for communications with a user equipment based at least in part on the time period, for example, as described herein with respect to FIGS. 6A-8.

Method 1000 then proceeds to block 1015 with communicating with the user equipment based at least in part on the one or more TDD transmission patterns and the duration of the propagation delay. In certain aspects, the one or more TDD transmission patterns further indicates a second duration of the timing advance based at least in part on the duration of the propagation delay. In certain aspects, the second duration of the timing advance is greater than the first duration of the timing advance.

In certain aspects, the one or more TDD transmission patterns indicate that a first time gap is arranged in time between the first downlink slot and the one or more first uplink slots, the one or more TDD transmission patterns indicate that the one or more first uplink slots are followed in time by a second time gap, and the duration of the propagation delay is based at least in part on the first time gap and the second time gap. In certain aspects, the time period includes the second time gap. In certain aspects, the second duration of the timing advance is based at least in part on the first time gap and the second time gap.

In certain aspects, the duration of the propagation delay is based at least in part on a sum of the first time gap and the second time gap. In certain aspects, the second duration of the timing advance is based at least in part on a sum of the first time gap and the second time gap.

In certain aspects, the one or more TDD transmission patterns include a first TDD transmission pattern and a second TDD transmission pattern, the first TDD transmission pattern indicates that the first time gap is arranged in time between the first downlink slot and the one or more first uplink slots, and the second TDD transmission pattern indicates a duration of the second time gap.

In certain aspects, the one or more TDD transmission patterns further indicate that the one or more first uplink slots are followed in time by one or more second downlink slots, and that the one or more second downlink slots are allocated during a propagation time period associated with the one or more first uplink slots, wherein the duration of the propagation delay includes the propagation time period. In certain aspects, the second duration of the timing advance includes the propagation time period.

In certain aspects, the one or more TDD transmission patterns include a first TDD transmission pattern and a second TDD transmission pattern, the first TDD transmission pattern indicates that the first downlink slot is followed in time by the one or more first uplink slots, and the second TDD transmission pattern indicates that the one or more first uplink slots are followed in time by the one or more second downlink slots. In certain aspects, the time period includes at least a portion of the one or more second downlink slots.

In certain aspects, the one or more TDD transmission patterns further indicate that the one or more second downlink slots include at least one downlink slot that overlaps in time with at least one uplink slot of the one or more first uplink slots for frequency division duplex communications at the apparatus.

In certain aspects, block 1015 includes obtaining signaling from the user equipment via an NTN communications link, such as the service link 534 of FIG. 5.

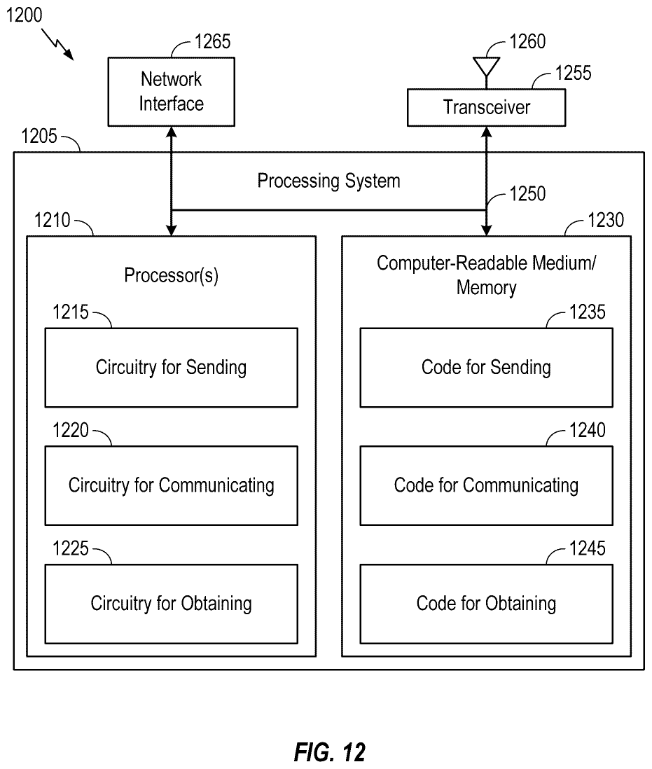

In certain aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device 1100. In some aspects, communications device 1100 is a user equipment, such as UE 104 described above with respect to FIGS. 1 and 3.

The communications device 1100 includes a processing system 1105 coupled to a transceiver 1155 (e.g., a transmitter and/or a receiver). The transceiver 1155 is configured to transmit and receive signals for the communications device 1100 via an antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code), including code 1135-1145, that when executed by the one or more processors 1110, enable and cause the one or more processors 1110 to perform the method 900 described with respect to FIG. 9, or any aspect related to it, including any operations described in relation to FIG. 9. Note that reference to a processor performing a function of communications device 1100 may include one or more processors performing that function of communications device 1100, such as in a distributed fashion.

In the depicted example, computer-readable medium/memory 1130 stores code for obtaining 1135, code for communicating 1140, and code for transmitting (or sending) 1145. Processing of the code 1135-1145 may enable and cause the communications device 1100 to perform the method 900 described with respect to FIG. 9, or any aspect related to it.

The one or more processors 1110 include circuitry configured to implement (e.g., execute) the code (e.g., executable instructions) stored in the computer-readable medium/memory 1130, including circuitry for obtaining 1115, circuitry for communicating 1120, and circuitry for transmitting (or sending) 1125. Processing with circuitry 1115-1125 may enable and cause the communications device 1100 to perform the method 900 described with respect to FIG. 9, or any aspect related to it.

More generally, means for communicating, transmitting, sending or outputting for transmission may include the transceivers 354, antenna(s) 352, transmit processor 364, TX MIMO processor 366, AI processor 370, and/or controller/processor 380 of the UE 104 illustrated in FIG. 3, transceiver 1155 and/or antenna 1160 of the communications device 1100 in FIG. 11, and/or one or more processors 1110 of the communications device 1100 in FIG. 11. Means for communicating, receiving or obtaining may include the transceivers 354, antenna(s) 352, receive processor 358, AI processor 370, and/or controller/processor 380 of the UE 104 illustrated in FIG. 3, transceiver 1155 and/or antenna 1160 of the communications device 1100 in FIG. 11, and/or one or more processors 1110 of the communications device 1100 in FIG. 11.

FIG. 12 depicts aspects of an example communications device 1200. In some aspects, communications device 1200 is a network entity, such as BS 102 of FIGS. 1 and 3, or a disaggregated base station as discussed with respect to FIG. 2.

The communications device 1200 includes a processing system 1205 coupled to a transceiver 1255 (e.g., a transmitter and/or a receiver) and/or a network interface 1265. The transceiver 1255 is configured to transmit and receive signals for the communications device 1200 via an antenna 1260, such as the various signals as described herein. The network interface 1265 is configured to obtain and transmit signals for the communications device 1200 via communications link(s), such as a backhaul link, midhaul link, and/or fronthaul link as described herein, such as with respect to FIG. 2. The processing system 1205 may be configured to perform processing functions for the communications device 1200, including processing signals received and/or to be transmitted by the communications device 1200.

The processing system 1205 includes one or more processors 1210. In various aspects, one or more processors 1210 may be representative of one or more of receive processor 338, transmit processor 320, TX MIMO processor 330, and/or controller/processor 340, as described with respect to FIG. 3. The one or more processors 1210 are coupled to a computer-readable medium/memory 1230 via a bus 1250. In certain aspects, the computer-readable medium/memory 1230 is configured to store instructions (e.g., computer-executable code), including code 1235-1245, that when executed by the one or more processors 1210, enable and cause the one or more processors 1210 to perform the method 1000 described with respect to FIG. 10, or any aspect related to it, including any operations described in relation to FIG. 10. Note that reference to a processor of communications device 1200 performing a function may include one or more processors of communications device 1200 performing that function, such as in a distributed fashion.

In the depicted example, the computer-readable medium/memory 1230 stores code for transmitting (or sending) 1235, code for communicating 1240, and code for obtaining 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code (e.g., executable instructions) stored in the computer-readable medium/memory 1230, including circuitry for transmitting (or sending) 1215, circuitry for communicating 1220, and circuitry for obtaining 1225. Processing with circuitry 1215-1225 may enable and cause the communications device 1200 to perform the method 1000 described with respect to FIG. 10, or any aspect related to it.

Various components of the communications device 1200 may provide means for performing the method 1000 described with respect to FIG. 10, or any aspect related to it. Means for communicating, transmitting, sending or outputting for transmission may include the transceivers 332, antenna(s) 334, transmit processor 320, TX MIMO processor 330, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12. Means for communicating, receiving or obtaining may include the transceivers 332, antenna(s) 334, receive processor 338, AI processor 318, and/or controller/processor 340 of the BS 102 illustrated in FIG. 3, transceiver 1255, antenna 1260, and/or network interface 1265 of the communications device 1200 in FIG. 12, and/or one or more processors 1210 of the communications device 1200 in FIG. 12.

### Example Clauses

Implementation examples are described in the following numbered clauses:

Clause 1: A method for wireless communications by an apparatus comprising: obtaining an indication of a first duration of a timing advance for uplink transmission; obtaining an indication of one or more TDD transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a network entity based at least in part on the time period; and communicating with the network entity based at least in part on the one or more TDD transmission patterns and the duration of the propagation delay.

Clause 2: The method of Clause 1, wherein communicating with the network entity comprises transmitting signaling, scheduled in the one or more first uplink slots, beginning at a time occasion based at least in part on the duration of the propagation delay.

Clause 3: The method of any one of Clauses 1-2, further comprising obtaining an indication of a first duration of a timing advance for uplink transmission; the one or more TDD transmission patterns further indicates a second duration of the timing advance based at least in part on the duration of the propagation delay; and the second duration of the timing advance is greater than the first duration of the timing advance.

Clause 4: The method of any one of Clauses 1-3, wherein: the one or more TDD transmission patterns indicate that a first time gap is arranged in time between the first downlink slot and the one or more first uplink slots, the one or more TDD transmission patterns indicate that the one or more first uplink slots are followed in time by a second time gap, the duration of the propagation delay is based at least in part on the first time gap and the second time gap, and the time period includes the second time gap

Clause 5: The method of Clause 4, wherein the duration of the propagation delay is based at least in part on a sum of the first time gap and the second time gap.

Clause 6: The method of Clause 4 or 5, wherein: the one or more TDD transmission patterns include a first TDD transmission pattern and a second TDD transmission pattern, the first TDD transmission pattern indicates that the first time gap is arranged in time between the first downlink slot and the one or more first uplink slots, and the second TDD transmission pattern indicates a duration of the second time gap.

Clause 7: The method of any one of Clauses 1-6, wherein the one or more TDD transmission patterns further indicate that the one or more first uplink slots are followed in time by one or more second downlink slots, and that the one or more second downlink slots are allocated during a propagation time period associated with the one or more first uplink slots, wherein the duration of the propagation delay includes the propagation time period.

Clause 8: The method of Clause 7, wherein: the one or more TDD transmission patterns include a first TDD transmission pattern and a second TDD transmission pattern, the first TDD transmission pattern indicates that the first downlink slot is followed in time by the one or more first uplink slots, the second TDD transmission pattern indicates that the one or more first uplink slots are followed in time by the one or more second downlink slots, and the time period includes at least a portion of the one or more second downlink slots.

Clause 9: The method of Clause 7 or 8, wherein the one or more TDD transmission patterns further indicate that the one or more second downlink slots include at least one downlink slot that overlaps in time with at least one uplink slot of the one or more first uplink slots for frequency division duplex communications at the network entity.

Clause 10: The method of any one of Clauses 1-9, wherein communicating with the network entity comprises transmitting signaling to the network entity via an NTN communications link.

Clause 11: A method for wireless communications by an apparatus comprising: transmitting an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a user equipment based at least in part on the time period; and communicating with the user equipment based at least in part on the one or more TDD transmission patterns and the second duration of the timing advance.

Clause 12: The method of Clause 11, further comprising transmitting an indication of a first duration of a timing advance for uplink transmission, wherein the one or more TDD transmission patterns further indicates a second duration of the timing advance based at least in part on the duration of the propagation delay; and the second duration of the timing advance is greater than the first duration of the timing advance.

Clause 13: The method of any one of Clauses 11-12, wherein: the one or more TDD transmission patterns indicate that a first time gap is arranged in time between the first downlink slot and the one or more first uplink slots, the one or more TDD transmission patterns indicate that the one or more first uplink slots are followed in time by a second time gap, the duration of the propagation delay is based at least in part on the first time gap and the second time gap, and the time period includes the second time gap.

Clause 14: The method of Clause 13, wherein the duration of the propagation delay is based at least in part on a sum of the first time gap and the second time gap.

Clause 15: The method of Clause 13 or 14, wherein: the one or more TDD transmission patterns include a first TDD transmission pattern and a second TDD transmission pattern, the first TDD transmission pattern indicates that the first time gap is arranged in time between the first downlink slot and the one or more first uplink slots, and the second TDD transmission pattern indicates a duration of the second time gap.

Clause 16: The method of any one of Clauses 11-15, wherein the one or more TDD transmission patterns further indicate that the one or more first uplink slots are followed in time by one or more second downlink slots, and that the one or more second downlink slots are allocated during a propagation time period associated with the one or more first uplink slots, wherein the duration of the propagation delay includes the propagation time period.

Clause 17: The method of Clause 16, wherein: the one or more TDD transmission patterns include a first TDD transmission pattern and a second TDD transmission pattern, the first TDD transmission pattern indicates that the first downlink slot is followed in time by the one or more first uplink slots, the second TDD transmission pattern indicates that the one or more first uplink slots are followed in time by the one or more second downlink slots, and the time period includes at least a portion of the one or more second downlink slots.

Clause 18: The method of Clause 16 or 17, wherein the one or more TDD transmission patterns further indicate that the one or more second downlink slots include at least one downlink slot that overlaps in time with at least one uplink slot of the one or more first uplink slots for frequency division duplex communications at the apparatus.

Clause 19: The method of any one of Clauses 11-18, wherein communicating with the user equipment comprises obtaining signaling from the user equipment via an NTN communications link.

Clause 20: One or more apparatuses, comprising: one or more memories comprising executable instructions; and one or more processors configured to execute the executable instructions and cause the one or more apparatuses to perform a method in accordance with any one of Clauses 1-19.

Clause 21: One or more apparatuses, comprising: one or more memories; and one or more processors, coupled to the one or more memories, configured to cause the one or more apparatuses to perform a method in accordance with any one of Clauses 1-19.

Clause 22: One or more apparatuses, comprising: one or more memories; and one or more processors, coupled to the one or more memories, configured to perform a method in accordance with any one of Clauses 1-19.

Clause 23: One or more apparatuses, comprising means for performing a method in accordance with any one of Clauses 1-19.

Clause 24: One or more non-transitory computer-readable media comprising executable instructions that, when executed by one or more processors of one or more apparatuses, cause the one or more apparatuses to perform a method in accordance with any one of Clauses 1-19.

Clause 25: One or more computer program products embodied on one or more computer-readable storage media comprising code for performing a method in accordance with any one of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an ASIC, a field programmable gate array (FPGA) or other programmable logic device (PLD), discrete gate or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining or the like. Also, “determining” may include receiving (e.g., receiving information), accessing (e.g., accessing data in a memory) or the like. Also, “determining” may include resolving, selecting, choosing, establishing or the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “a controller,” “a memory,” “a transceiver,” “an antenna,” “the processor,” “the controller,” “the memory,” “the transceiver,” “the antenna,” etc.), unless otherwise specifically stated, should be understood to refer to one or more elements (e.g., “one or more processors,” “one or more controllers,” “one or more memories,” “one more transceivers,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus configured for wireless communications, comprising:
one or more memories; and
one or more processors coupled to the one or more memories, the one or more processors being configured to cause the apparatus to:
obtain an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a network entity based at least in part on the time period; and
communicate with the network entity based at least in part on the one or more TDD transmission patterns and the duration of the propagation delay.

2. The apparatus of claim 1, wherein to communicate with the network entity, the one or more processors are configured to cause the apparatus to:
transmit signaling, scheduled in the one or more first uplink slots, beginning at a time occasion based at least in part on the duration of the propagation delay.

3. The apparatus of claim 1, wherein the one or more processors are configured to cause the apparatus to:
obtain an indication of a first duration of a timing advance for uplink transmission, wherein the one or more TDD transmission patterns further indicates a second duration of the timing advance based at least in part on the duration of the propagation delay, and wherein the second duration of the timing advance is greater than the first duration of the timing advance.

4. The apparatus of claim 1, wherein the one or more TDD transmission patterns indicate that a first time gap is arranged in time between the first downlink slot and the one or more first uplink slots, and that the one or more first uplink slots are followed in time by a second time gap, wherein the duration of the propagation delay is based at least in part on the first time gap and the second time gap, and wherein the time period includes the second time gap.

5. The apparatus of claim 4, wherein the duration of the propagation delay is based at least in part on a sum of the first time gap and the second time gap.

6. The apparatus of claim 4, wherein:
the one or more TDD transmission patterns include a first TDD transmission pattern and a second TDD transmission pattern,
the first TDD transmission pattern indicates that the first time gap is arranged in time between the first downlink slot and the one or more first uplink slots, and
the second TDD transmission pattern indicates a duration of the second time gap.

7. The apparatus of claim 1, wherein the one or more TDD transmission patterns further indicate that the one or more first uplink slots are followed in time by one or more second downlink slots, and that the one or more second downlink slots are allocated during a propagation time period associated with the one or more first uplink slots, wherein the duration of the propagation delay includes the propagation time period.

8. The apparatus of claim 7, wherein the one or more TDD transmission patterns include a first TDD transmission pattern and a second TDD transmission pattern, wherein the first TDD transmission pattern indicates that the first downlink slot is followed in time by the one or more first uplink slots, wherein the second TDD transmission pattern indicates that the one or more first uplink slots are followed in time by the one or more second downlink slots, and wherein the time period includes at least a portion of the one or more second downlink slots.

9. The apparatus of claim 7, wherein the one or more TDD transmission patterns further indicate that the one or more second downlink slots include at least one downlink slot that overlaps in time with at least one uplink slot of the one or more first uplink slots for frequency division duplex communications at the network entity.

10. The apparatus of claim 1, wherein to communicate with the network entity, the one or more processors are configured to cause the apparatus to:
transmit signaling to the network entity via a non-terrestrial network (NTN) communications link.

11. An apparatus configured for wireless communications, comprising:
one or more memories; and
one or more processors coupled to the one or more memories, the one or more processors being configured to cause the apparatus to:
transmit an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a user equipment based at least in part on the time period; and
communicate with the user equipment based at least in part on the one or more TDD transmission patterns and the duration of the propagation delay.

12. The apparatus of claim 11, wherein the one or more processors are configured to cause the apparatus to:
transmit an indication of a first duration of a timing advance for uplink transmission, wherein the one or more TDD transmission patterns further indicates a second duration of the timing advance based at least in part on the duration of the propagation delay, and wherein the second duration of the timing advance is greater than the first duration of the timing advance.

13. The apparatus of claim 11, wherein the one or more TDD transmission patterns indicate that a first time gap is arranged in time between the first downlink slot and the one or more first uplink slots, and that the one or more first uplink slots are followed in time by a second time gap, wherein the duration of the propagation delay is based at least in part on the first time gap and the second time gap, and wherein the time period includes the second time gap.

14. The apparatus of claim 13, wherein the duration of the propagation delay is based at least in part on a sum of the first time gap and the second time gap.

15. The apparatus of claim 13, wherein the one or more TDD transmission patterns include a first TDD transmission pattern and a second TDD transmission pattern, wherein the first TDD transmission pattern indicates that the first time gap is arranged in time between the first downlink slot and the one or more first uplink slots, and wherein the second TDD transmission pattern indicates a duration of the second time gap.

16. The apparatus of claim 11, wherein the one or more TDD transmission patterns further indicate that the one or more first uplink slots are followed in time by one or more second downlink slots, and that the one or more second downlink slots are allocated during a propagation time period associated with the one or more first uplink slots, wherein the duration of the propagation delay includes the propagation time period.

17. The apparatus of claim 16, wherein the one or more TDD transmission patterns include a first TDD transmission pattern and a second TDD transmission pattern, wherein the first TDD transmission pattern indicates that the first downlink slot is followed in time by the one or more first uplink slots, wherein the second TDD transmission pattern indicates that the one or more first uplink slots are followed in time by the one or more second downlink slots, and wherein the time period includes at least a portion of the one or more second downlink slots.

18. The apparatus of claim 16, wherein the one or more TDD transmission patterns further indicate that the one or more second downlink slots include at least one downlink slot that overlaps in time with at least one uplink slot of the one or more first uplink slots for frequency division duplex communications at the apparatus.

19. The apparatus of claim 11, wherein to communicate with the user equipment, the one or more processors are configured to cause the apparatus to:
obtain signaling from the user equipment via a non-terrestrial network (NTN) communications link.

20. A method for wireless communications by an apparatus, comprising:
obtaining an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a network entity based at least in part on the time period; and
communicating with the network entity based at least in part on the one or more TDD transmission patterns and the duration of the propagation delay.

21. A method for wireless communications by an apparatus, comprising:
transmitting an indication of one or more time division duplex (TDD) transmission patterns, wherein the one or more TDD transmission patterns indicate that a first downlink slot is followed in time by one or more first uplink slots, and that the one or more first uplink slots are followed in time by a time period, and wherein the one or more TDD transmission patterns further indicate a duration of a propagation delay for communications with a user equipment based at least in part on the time period; and
communicating with the user equipment based at least in part on the one or more TDD transmission patterns and the duration of the propagation delay.
